(19) United States
(12) Patent Application Publication
(10) Pub. No.: US 2021/0284442 A1
(43) Pub. Date: Sep. 16, 2021

(54) TRASH RECEPTACLE WITH BAG DISPENSER AND AIR FRESHENER

(71) Applicants: Aaron SIEGEL, Oak Park, MI (US); Adam SIEGEL, Oak Park, MI (US); Aviel SIEGEL, Oak Park, MI (US)

(72) Inventors: Aaron SIEGEL, Oak Park, MI (US); Adam SIEGEL, Oak Park, MI (US); Aviel SIEGEL, Oak Park, MI (US)

(21) Appl. No.: 17/003,212

(22) Filed: Aug. 26, 2020

Related U.S. Application Data
(60) Provisional application No. 62/987,470, filed on Mar. 10, 2020.

(51) Int. Cl. B65F 1/06

(52) U.S. Cl. CPC B65F 1/062; B65F 2210/129; B65F 2250/11; B65F 2250/114; B65F 2210/1815

(57) ABSTRACT

A trash receptacle including a hollow receptacle body having an open top end and a closed bottom end, the hollow receptacle body having a bag dispenser receptacle operatively connected to a bag dispenser port on an outer portion, and an air freshener receiver operatively connected to the hollow receptacle body and including an airflow mechanism for flowing air between the air freshener receiver and the hollow receptacle body. A method of using the trash receptacle by removing a bag from the bag dispenser receptacle on the outer portion of the hollow receptacle body, inserting the bag into the hollow receptacle body, and flowing air through the airflow mechanism and the air freshener receiver to maintain a clean smelling trash receptacle.

### BACKGROUND OF THE INVENTION

### 1. Technical Field

The present invention relates to trash receptacles and methods of dispensing bags and freshening air in trash receptacles.

### 2. Background Art

Most trash receptacles (garbage cans or bins) do not include bags or a place to store bags so that they are readily available when one needs to be changed. Due to trash receptacle design or tears in bags, unpleasant odors may pose a problem.

One device that attempts to solve this problem is a “Trash Helper”, which contains a roll of garbage bags and is placed at the bottom of the trash receptacle. When a full bag of garbage is removed, the next empty bag is dragged up attached to the bottom of the full bag. However, this design can be disadvantageous if a bag has a leak, and a user has to reach all the way into the bottom of the trash receptacle to access the bags if the next one does not come out or to replace the bags.

U.S. Pat. No. 8,327,055 to Zawrotny discloses a trash bag receptacle with trash bag dispenser system has an open top, a bottom floor, and a front wall. The front wall of the container has a slotted opening which extends from the bottom floor upwards along substantially the entire length of the front wall. A channel member with an open top and bottom extends inward into the container, enclosing the slotted opening within the container. A base section supporting the container has an interior space in which a roll of trash bags is rotatably mounted. A single trash bag from the roll is threaded from the interior space and through the channel. The trash bag exits from the open top of the channel where its perforation is separated from the roll of trash bags. The adjacent, next trash bag on the roll remains in the channel member. A new, clean trash bag is thus easily accessible to the user by simply pulling the next trash bag which is exposed through the open top of the channel member. However, with this device, it is not convenient to change a trash bag on a perforated roll as it would require two hands to retrieve a new bag, one hand to hold the roll and the other hand to tear the bag from the roll. The device is also easily knocked over while using two hands to retrieve the bag, as there is no way to stabilize the receptacle with no free hands. The garbage bag roll also takes up a lot of space.

Simple Human makes a trash can with voice and motion control that also includes a trash liner pocket. Liners can be inserted from outside the can and dispensed from inside the can. The trash can must be open to remove a new liner and an individual has to reach within the can to pull the new liner out.

There remains a need for a trash receptacle with an easy to use bag dispenser.

### SUMMARY OF THE INVENTION

The present invention provides for a trash receptacle including a hollow receptacle body having an open top end and a closed bottom end, the hollow receptacle body having a bag dispenser receptacle operatively connected to a bag dispenser port on an outer portion, and an air freshener receiver operatively connected to the hollow receptacle body and including an airflow mechanism for flowing air between the air freshener receiver and the hollow receptacle body.

The present invention provides for a method of using the trash receptacle by removing a bag from the bag dispenser receptacle on the outer portion of the hollow receptacle body, inserting the bag into the hollow receptacle body, and flowing air through the airflow mechanism and the air freshener receiver to maintain a clean smelling trash receptacle.

### DESCRIPTION OF THE DRAWINGS

Other advantages of the present invention are readily appreciated as the same becomes better understood by reference to the following detailed description when considered in connection with the accompanying drawings wherein:

FIG. 1 is a side view of the trash receptacle of the present invention;

FIG. 2A is a front view of the trash receptacle, and FIG. 2B is a front view of an open door and bag dispenser port;

FIG. 3 is a back view of the trash receptacle;

FIG. 4 is a top view of the trash receptacle;

FIG. 5 is a top perspective view of an air freshener dome;

FIG. 6 is a bottom view of the trash receptacle;

FIG. 7 is a side view of the air freshener dome;

FIG. 8 is a side perspective view of trash receptacles;

FIG. 9 is a side perspective view of a second embodiment of the trash receptacle;

FIG. 10 is a front view of a second embodiment of the trash receptacle;

FIG. 11 is a side perspective view of a second embodiment of the trash receptacle;

FIG. 12A is a front perspective view of a third embodiment of the trash receptacle with a bag dispenser mechanism as a roll mechanism at an upper outer portion, and FIG. 12B is a front perspective view of a third embodiment of the trash receptacle with the roll mechanism either at a center portion or at an outer bottom portion; and

FIG. 13 is a side perspective view of an air freshener receiver including perforations on an outer side.

### DETAILED DESCRIPTION OF THE INVENTION

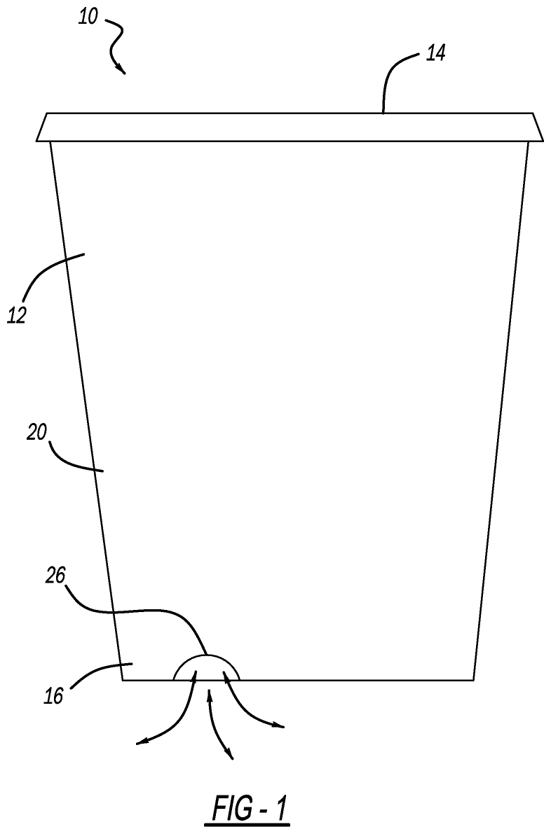

The present invention generally provides for a trash receptacle 10, shown in FIGS. 1, 2A, 3, 4, and 6 including a hollow receptacle body 12 having an open top end 14 and a closed bottom end 16, the hollow receptacle body 12 having a bag dispenser receptacle 28 operatively connected to a bag dispenser port 18 on an outer portion 20 (or optionally on an inner portion 24), and an air freshener receiver 21 operatively connected to the hollow receptacle body 12 and including an airflow mechanism 25 for flowing air between the air freshener receiver 21 and the hollow receptacle body 12.

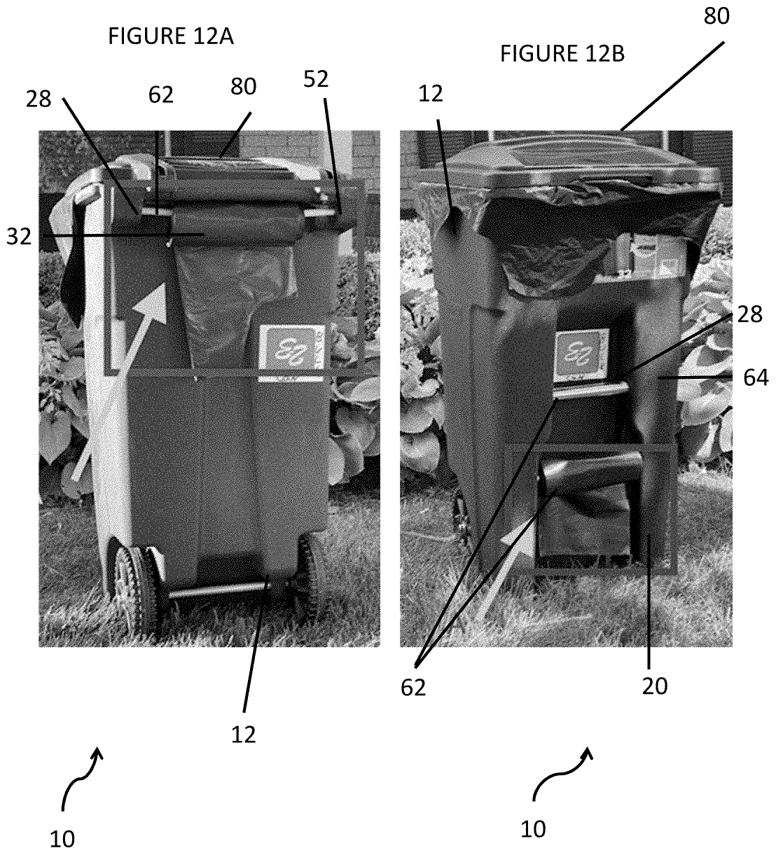

The trash receptacle 10 and its constituent parts can be made of plastic or metal, can include recycled materials, and can be any size, such as small, medium, or large. The trash receptacle 10 can optionally include a lid 80 (shown in FIGS. 12A and 12B) separate or operatively attached thereto. The trash receptacle 10 can be in any color and include graphic designs or logos.

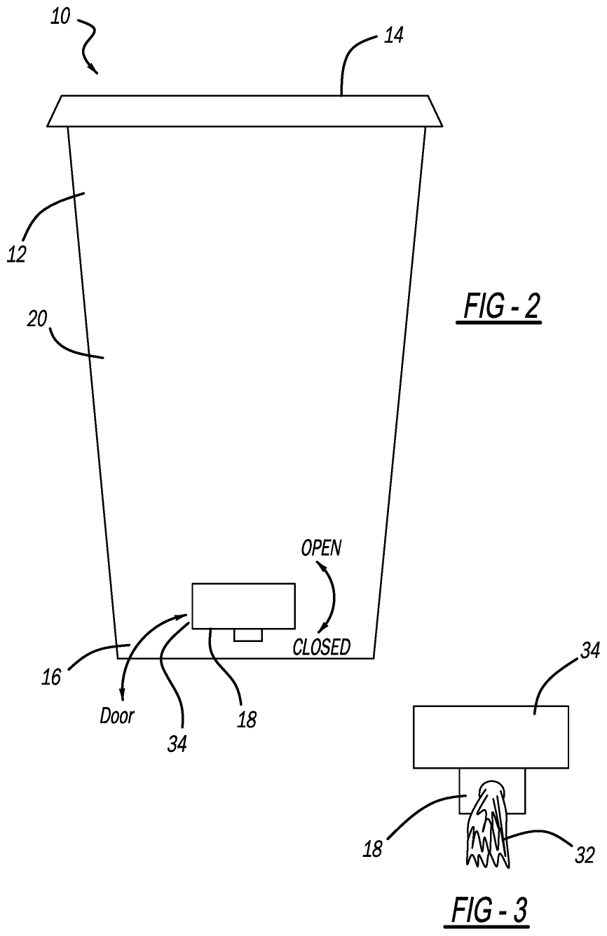

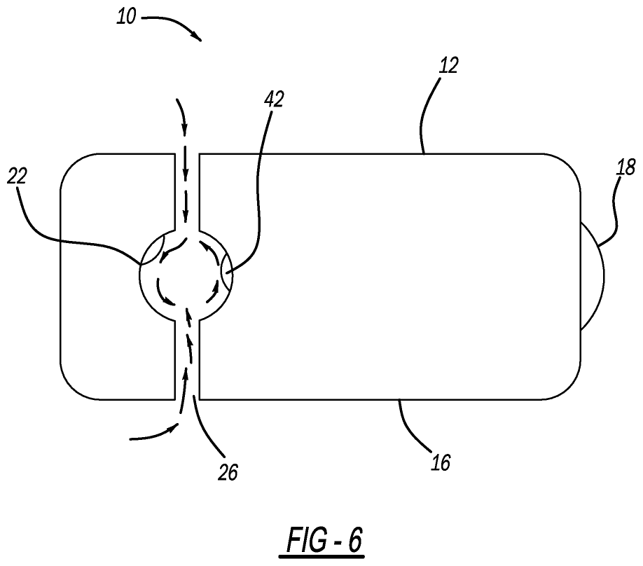

FIG. 1 shows a side view of a first embodiment of the trash receptacle 10 with the airflow mechanism 25 including airflow passageway 26. Each side of the trash receptacle 10 includes the airflow passageway 26 such that air is capable of flowing from one side to the other (FIG. 6), and so that air circulates into the hollow receptacle body 12. FIG. 2A is a front view of the trash receptacle 10, and FIG. 3 is a back view of the trash receptacle 10.

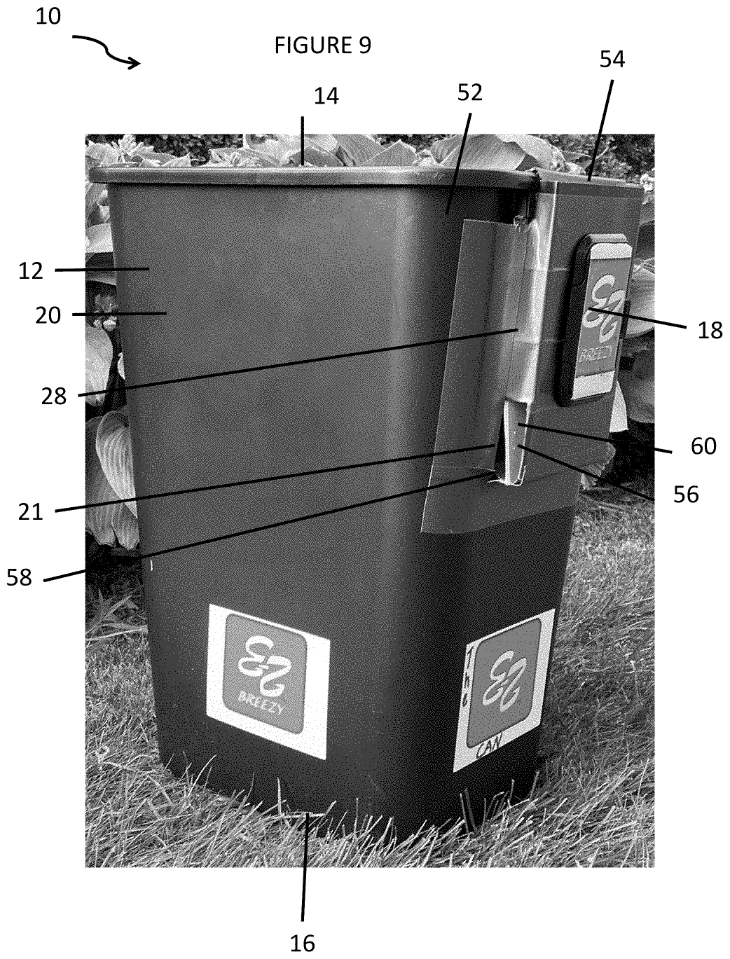

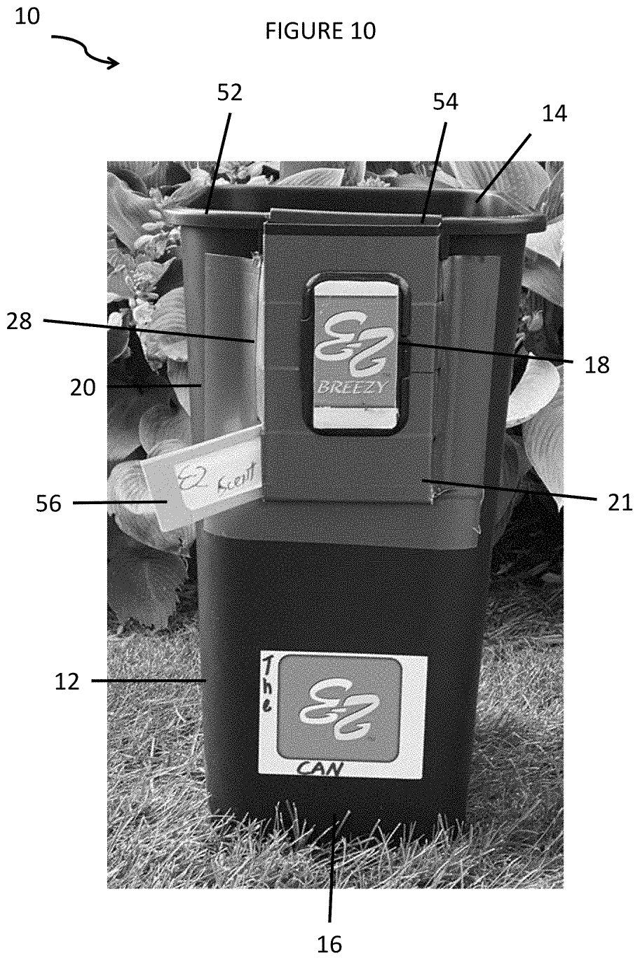

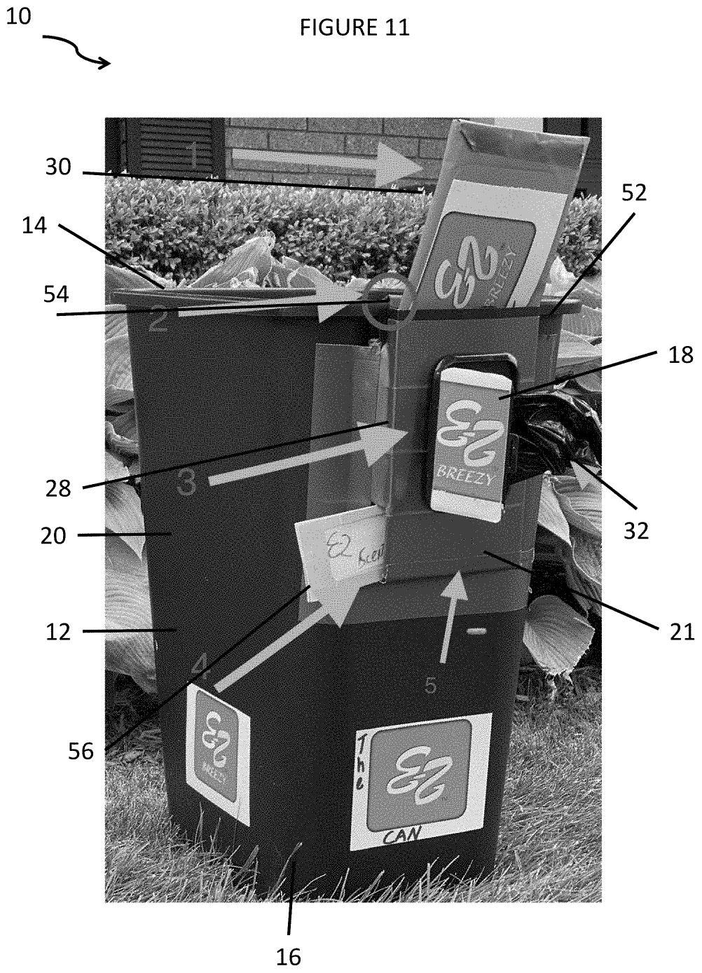

The bag dispenser receptacle 28 can be located at any suitable place or height on the inner portion 24 or outer portion 20 of the hollow receptacle body 12, with the bag dispenser port 18 located at a corresponding place or height on the outer portion 20. In one embodiment, the bag dispenser receptacle 28 is located at the inner bottom portion 25. In a second embodiment, the bag dispenser receptacle 28 is located on an upper outer portion 52, shown in FIGS. 9-11. In a third embodiment, the bag dispenser receptacle 28 is a roll mechanism 62 for receiving a roll of bags 32 operatively attached to the hollow receptacle body 12 at an upper outer portion 52, a center portion 64, or at an outer bottom portion 20. FIG. 12A shows the trash receptacle 10 with the roll mechanism 62 at the upper outer portion 52, and FIG. 12B shows the trash receptacle 10 with a roll mechanism 62 either at the center portion 64 or at an outer bottom portion 20. The roll mechanism 62 is essentially a rod that operatively and removably attached at a portion of the bag dispenser receptacle 28 through any suitable securing mechanism, such as a spring loaded securing mechanism. The roll mechanism 62 can easily be detached to load a roll of bags 32. The roll mechanism 62 can also include a cover or a door 34 that fits over a roll of bags 32 (described below).

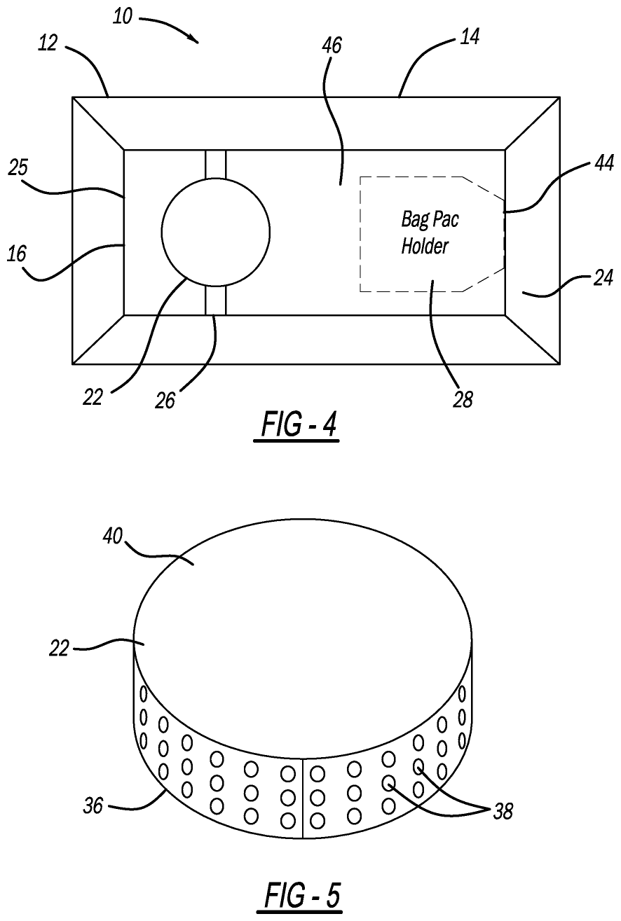

The bag dispenser receptacle 28 can hold a bag pack 30 including multiple individual bags 32 and can be sized to fit a suitable bag pack 30. The size of the bag dispenser receptacle 28 can vary depending on size of the bag 32 or the trash receptacle 10. Bag packs 30 can come in any suitable quantity, such as 12, 25, 48, 100, and 120. The bags 32 can be individual or removably attached to one another (such as on a roll). Bag packs 30 can be waterproof or water resistant. When a user buys a bag pack 30, any opening sealing the bag pack 30 can be torn off to expose the bags 32 and the bag pack 30 can be inserted into the dispenser receptacle 28 such that the opening lines up with the bag dispenser port 18. The bag pack 30 can be inserted from the outside of the trash receptacle 10 into the bag dispenser receptacle 28. The bag dispenser receptacle 28 can be narrower at a side 44 adjacent to the hollow receptacle body 12 than an opposite side 46, as shown in FIG. 4. The bag pack 30 can also have a matching shape. This shape slightly crushes the bags 32 as they exit the bag pack 30 and allows for easier separation of one bag 32 from another. The bag dispenser port 18 can optionally include a door 34 that covers the bag dispenser port 18 and is operatively attached to the hollow receptacle body 12 by any suitable mechanism and can be lifted as shown in FIG. 2B to access the bags 32. The bag dispenser receptacle 28 can also include a receptacle door 54 attached by any suitable mechanism, as shown in FIGS. 9-11, for easier insertion of a bag pack 30. The receptacle door 54 keeps debris out and can also be used to lock a bag 32 in place, preventing it from falling into the hollow receptacle body 12.

FIG. 4 shows an inside view of the trash receptacle 10. In a first embodiment, at the inner portion 24 (and preferably at the inner bottom portion 25) is the bag dispenser receptacle 28 and the air freshener receiver 21 is an air freshener dome 22 operatively connected to the airflow passageway 26. The air freshener dome 22 extends upwards vertically from the closed bottom end 16 and is cylindrical in shape but can be in other shapes. FIG. 5 is a top perspective view of the air freshener dome 22. The airflow mechanism 25 also includes perforations 38 in sides 36 of the air freshener dome 22 that allow air to flow into the hollow receptacle body 12, and a top 40 is solid to prevent debris falling through the trash receptacle 10.

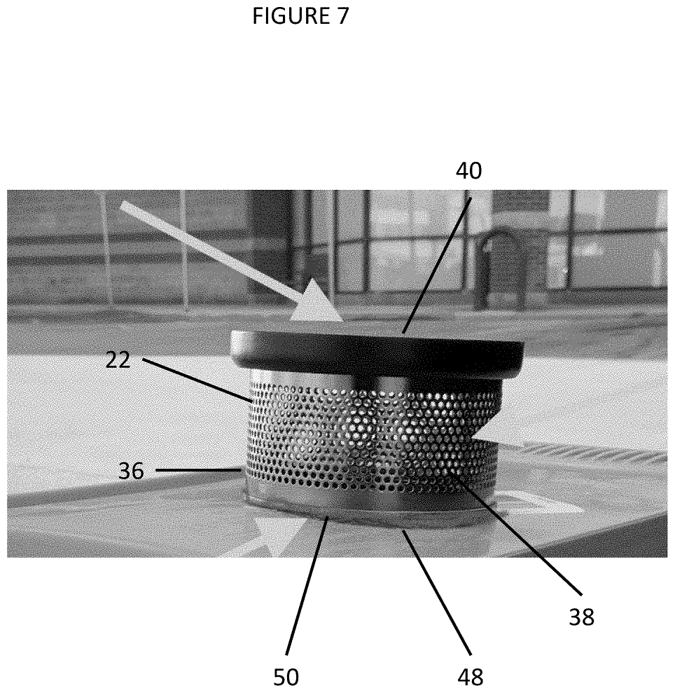

FIG. 6 shows a bottom exterior view of the trash receptacle 10 and shows how air can flow through airflow passageway 26 and to the air freshener dome 22. The airflow passageway 26 provides several advantages. Air can pass through the trash receptacle 10, allowing for easier removal of a bag 32 of garbage, because the air passing through avoids the suction that is often created when extracting the bag 32. When extracting the bag 32, it automatically draws air through the air freshener dome 22 and keeps the can smelling fresh. It is also easier for a user to separate the trash receptacles 10 at a store when purchasing. An air freshener puck of any desired scent (not shown) can be inserted in the air freshener dome 22 and secured with at least one holding mechanism 42, such as a notch or a clip, such that the air freshener snaps into the air freshener dome 22. The air freshener puck can be removed easily by using a screwdriver or similar tool to pry it out from the holding mechanism 42, and a new air freshener puck can be inserted. A lip 48 can be provided at a perimeter of a bottom edge 50 of the air freshener dome 22 where the air freshener dome 22 meets the bottom inside end 16 of the trash receptacle 10 to prevent liquid from leaking out of the trash receptacle 10. The air freshener dome 22 is also shown in FIG. 7.

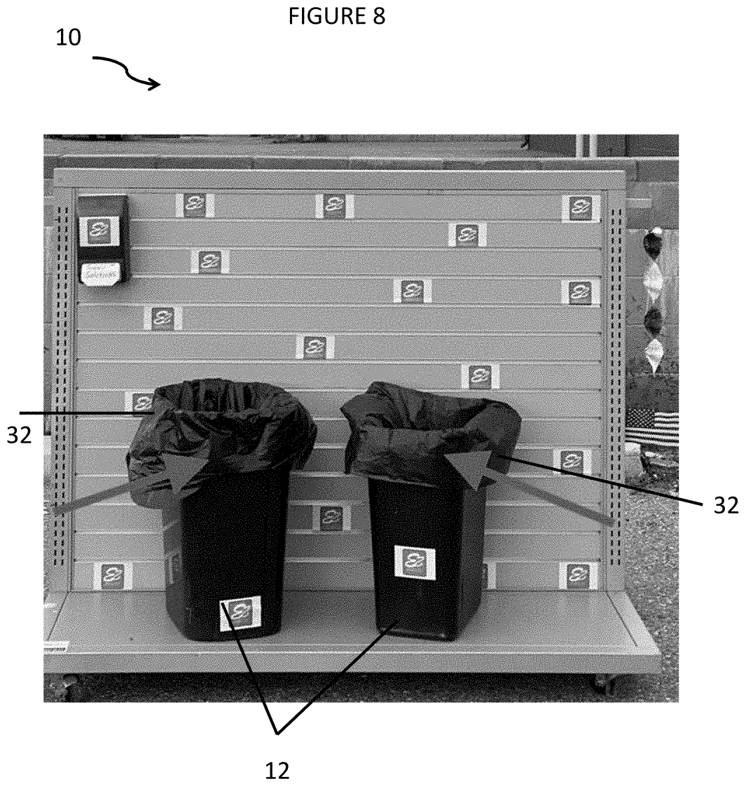

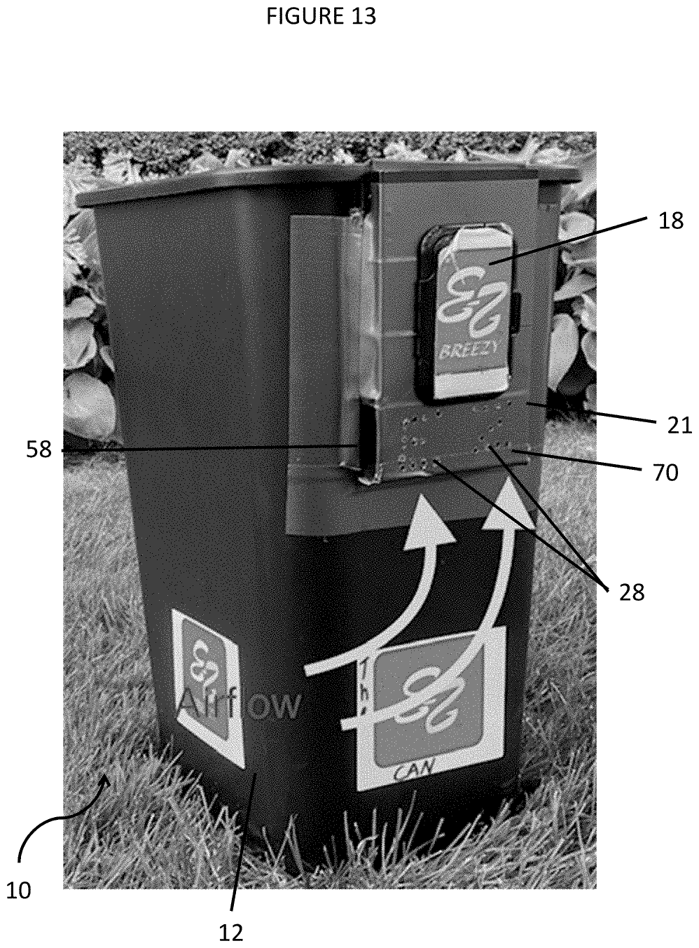

A second embodiment is shown in FIGS. 8-11. FIG. 8 shows the trash receptacle 10 with a bag 32 inserted. FIG. 9 shows the bag dispenser receptacle 28 on the upper outer portion 52 of the hollow receptacle body 12. The air freshener receiver 21 is operatively attached to the hollow receptacle body 12 under the bag dispenser receptacle 28 at any suitable place on the upper outer portion 52. The air freshener receiver 21 can be shaped like a slot to receive a stick air freshener 56 and includes an opening 60 for access to change the stick air freshener 56, however other shapes can also be used to receive a dome air freshener or brick shaped air freshener. The air freshener receiver 21 includes perforations 28 on a side 58 operatively attached to the hollow receptacle body 12 for facilitating air flow into the hollow receptacle body 12 (i.e. the portion/wall of the hollow receptacle body 12 where the air freshener receiver 21 is attached acts as the airflow mechanism 25). Perforations 28 can also be included on an outer side 70 of the air freshener receiver 21 (shown in FIG. 13) to additionally provide scent and freshen a cabinet or room in which the trash receptacle 10 is placed. The perforations 28 are big enough to allow for air to pass through, but small enough to keep debris out. It should be understood that in the third embodiment, the airflow mechanism 25 and the air freshener receiver 21 can be located as in either the first or second embodiments (i.e. at the bottom end 16 or upper outer portion 52, or also at the center portion 64 or outer bottom portion 24).

The present invention provides for a method of using the trash receptacle 10, by removing a bag 32 from the bag dispenser port 18 on the outer portion 20 of the hollow receptacle body 12, inserting the bag 32 into the hollow receptacle body 12, and flowing air through the airflow mechanism 25 (such as through airflow passageways 26 or the perforations 28 between the air freshener receiver 21 and the hollow receptacle body 12) to maintain a clean smelling trash receptacle 10. More specifically, the door 34 can be opened to access the bag dispenser port 18. Before use, a bag pack 30 can be inserted into the bag dispenser receptacle 28. An air freshener puck, brick, or stick 56 can be inserted into the air freshener receiver 21. When it is desired to change the bag 32, a full bag 32 can be removed from the hollow receptacle body 12 while air flowing through the airflow mechanism 25 (through airflow passageway 26 in the first embodiment and perforations 38 of the air freshener receiver 21 in the first and second embodiment) to prevent suction of the bag 32 within the hollow receptacle body 12. When inserting a new bag 32, the airflow mechanism 25 reduces air pockets from forming between the bag 32 and the hollow receptacle body 12, which allows for more trash to be contained within the bag 32.

The present invention allows a user to naturally grab hold of the top end 14 of the trash receptacle 10 with one hand, applying the right amount of pressure to keep the trash receptacle 10 stable and the user more balanced when dispensing a new bag 32 with the other hand. In the second embodiment, these advantages are also present, and it allows the user to remain in a more erect position and can reach for a new bag 32 with less effort.

Throughout this application, various publications, including United States patents, are referenced by author and year and patents by number. Full citations for the publications are listed below. The disclosures of these publications and patents in their entireties are hereby incorporated by reference into this application in order to more fully describe the state of the art to which this invention pertains.

The invention has been described in an illustrative manner, and it is to be understood that the terminology, which has been used is intended to be in the nature of words of description rather than of limitation.

Obviously, many modifications and variations of the present invention are possible in light of the above teachings. It is, therefore, to be understood that within the scope of the appended claims, the invention can be practiced otherwise than as specifically described.

What is claimed is:

1. A trash receptacle comprising:
a hollow receptacle body including an open top end and a closed bottom end, said hollow receptacle body having a bag dispenser receptacle operatively connected to a bag dispenser port on an outer portion, and an air freshener receiver operatively connected to said hollow receptacle body and including an airflow mechanism for flowing air between said air freshener receiver and the hollow receptacle body.

2. The trash receptacle of claim 1, wherein said trash receptacle is made of a material chosen from plastic and metal.

3. The trash receptacle of claim 1, wherein said bag dispenser receptacle is located on an inner bottom portion of said hollow receptacle body.

4. The trash receptacle of claim 1, wherein said bag dispenser receptacle is located on an upper outer portion, a center portion, or an outer bottom portion of said hollow receptacle body.

5. The trash receptacle of claim 4, wherein said bag dispenser receptacle is a roll mechanism for receiving a roll of bags.

6. The trash receptacle of claim 1, wherein said bag dispenser receptacle holds a bag pack including multiple individual bags.

7. The trash receptacle of claim 6, wherein said bag dispenser receptacle is narrower at a side adjacent to said hollow receptacle body than an opposite side, allowing for crushing of bags as they exit said bag pack and easy separation of bags, and wherein said bag pack is a shape matching said bag dispenser receptacle.

8. The trash receptacle of claim 1, wherein said bag dispenser port further includes a door covering said bag dispenser port.

9. The trash receptacle of claim 8, wherein said bag dispenser receptacle includes a receptacle door for insertion of said bag pack.

10. The trash receptacle of claim 1, wherein said airflow mechanism includes an airflow passageway extending to each side of said trash receptacle on said closed bottom end and accesses said air freshener mechanism.

11. The trash receptacle of claim 10, wherein said air freshener receiver is an air freshener dome that extends upwards vertically from said closed bottom end.

12. The trash receptacle of claim 10, wherein said air freshener dome includes sides having perforations allowing air to flow into said hollow receptacle body and a solid top.

13. The trash receptacle of claim 10, wherein said air freshener dome further includes a lip at a perimeter of a bottom inside edge for preventing liquid from leaking out of said trash receptacle.

14. The trash receptacle of claim 10, wherein said air freshener dome receives an air freshener puck secured with at least one holding mechanism.

15. The trash receptacle of claim 1, wherein said air freshener receiver is a slot for receiving a stick or brick air freshener and is operatively attached to said hollow receptacle body under said bag dispenser receptacle and wherein said air freshener receiver includes an opening for access and changing said stick or brick air freshener.

16. The trash receptacle of claim 15, wherein said airflow mechanism includes perforations on a side of said air freshener receiver operatively attached to said hollow receptacle body for facilitating air flow into said hollow receptacle body.

17. The trash receptacle of claim 16, wherein said air freshener receiver includes perforations on an outer side.

18. A method of using a trash receptacle, including the steps of:
removing a bag from a bag dispenser receptacle on an outer portion of a hollow receptacle body of a trash receptacle;
inserting the bag into the hollow receptacle body; and
flowing air through an airflow mechanism and an air freshener receiver to maintain a clean smelling trash receptacle.

19. The method of claim 18, wherein said removing step further includes the step of opening a door to access a bag dispenser port operatively connected to the bag dispenser receptacle.

20. The method of claim 18, wherein said removing step further includes the step of tearing a bag from a roll on a roll mechanism.

21. The method of claim 18, wherein, before said removing step, further including the step of inserting a bag pack into the bag dispenser receptacle.

22. The method of claim 18, further including the step of removing a full bag of trash while flowing air through the airflow mechanism and allowing for easy removal of the bag and preventing suction within the trash receptacle.

23. The method of claim 22, wherein the air freshener receiver further includes perforations preventing suction of the bag and reducing air pockets forming between the bag and the hollow receptacle body.

24. The method of claim 18, further including the step of inserting an air freshener puck, brick, or stick in the air freshener receiver.

25. The method of claim 18, wherein said removing step allows a user to grab hold of a top end of the trash receptacle with one hand and apply pressure to keep the trash receptacle stable and the user balanced when dispensing a new bag with their other hand.
